(19) United States
(12) Patent Application Publication
(10) Pub. No.: US 2008/0113068 A1
(43) Pub. Date: May 15, 2008

(54) SOUP COMPOSITION, AND METHODS OF MAKING THE SAME

(75) Inventor: Scott F. GRIMSHAW, Marcellus, NY (US)

Correspondence Address: BURR & BROWN, PO BOX 7068, SYRACUSE, NY, 13261-7068, US

(73) Assignee: Tangidyne Corporation, Marcellus, NY (US)

(21) Appl. No.: 11/691,142

(22) Filed: Mar. 26, 2007

Related U.S. Application Data
(60) Provisional application No. 60/858,132, filed on Nov. 9, 2006.

(51) Int. Cl. A23P 1/00; A23L 1/0524; A23L 1/0562; A23L 1/39

(52) U.S. Cl. 426/104; 426/576; 426/577; 426/589

(57) ABSTRACT

A soup composition comprises an edible soup material and an edible binding/molding substance, and is in the form of a non-liquid shape. A method of making a soup composition comprises mixing an edible soup material with an edible binding/molding substance to provide a soup mixture, depositing the soup mixture into a mold, and molding the soup mixture into a non-liquid shape. A method of making a soup composition, comprises depositing into a mold a soup mixture comprising an edible soup material and an edible binding/molding substance, and molding the soup mixture into a non-liquid shape.

### CROSS-REFERENCE TO RELATED APPLICATIONS

This application claims the benefit of U.S. Provisional Patent Application No. 60/858,132, filed Nov. 9, 2006, the entirety of which is incorporated herein by reference.

### FIELD OF THE INVENTION

The present invention relates to an edible soup composition and methods of making such compositions.

### BACKGROUND OF THE INVENTION

Soup is a food which is well-known to the public. Served hot or cold, it can be enjoyed as an appetizer or, accompanied by a sandwich or salad, as a full meal. One of the most popular, namely, chicken soup, is even considered by many to be an effective treatment for the common cold.

Soup can be obtained either as a liquid or in dry, powdered form. One of the disadvantages of the powdered form is that the ingredients have been dried and then ground up, thereby losing the sensory appeal of liquid soup ingredients, which, although they have been cut up or sliced, still maintain the look and feel of “real” ingredients.

Accordingly, there is an ongoing need for non-liquid soup compositions which are less objectionable, and more appealing, to the senses of the consumer.

### BRIEF SUMMARY OF THE INVENTION

It is well-known that some consumers have an inherent objection to buying soup in non-liquid, powdered form because the powdered ingredients do not have the sensory appeal of their liquid soup counterparts.

The present invention provides a soup composition which minimizes the inherent objection to dry soup mixes. In accordance with some embodiments of the present invention, there is provided a soup composition which comprises the dry mix soup ingredients and which further comprises one or more additional ingredients which make it possible to provide the soup composition in a shape which resembles the natural shape of one or more of the natural foods (e.g., a tomato or a slice of a tomato) from which the soup mix is formed, and a soup composition as described above in such a natural food shape.

In a first aspect of the present invention, there is provided a soup composition, comprising at least one edible soup material and at least one edible binding/molding substance, the soup composition being in the form of a non-liquid shape.

In a second aspect of the present invention, there is provided a method of making a soup composition, comprising:

mixing at least one edible soup material with at least one edible binding/molding substance to provide a soup mixture;

depositing the soup mixture into a mold; and

molding the soup mixture into a non-liquid shape.

In a third aspect of the present invention, there is provided a method of making a soup composition, comprising:

depositing into a mold a soup mixture comprising at least one edible soup material and at least one edible binding/molding substance; and

molding the soup mixture into a non-liquid shape.

In some embodiments according to the first, second and third aspects of the present invention, the edible binding/molding substance is at least partially hot-water soluble.

In some embodiments according to the first, second and third aspects of the present invention, the edible soup material is powdered.

In some embodiments according to the first, second and third aspects of present invention, the edible binding/molding substance comprises at least one material selected from the group consisting of gelatin, agar, corn starch, and pectin.

In some embodiments according to the first, second and third aspects of the present invention:

the edible soup material comprises tomato soup, and the non-liquid shape is a tomato shape;

the edible soup material comprises onion soup, and the non-liquid shape is an onion shape;

the edible soup material comprises carrot soup, and the non-liquid shape is a carrot shape;

the edible soup material comprises potato soup, and the non-liquid shape is a potato shape;

the edible soup material comprises at least one vegetable, and the non-liquid shape is the shape of the at least one vegetable; or

the edible soup material comprises a bean, and the non-liquid shape is a bean shape

The invention may be more fully understood with reference to the accompanying drawings and the following detailed description of the invention.

### BRIEF DESCRIPTION OF THE DRAWING FIGURES

FIG. 1 depicts a soup composition according to a first representative embodiment of the present invention.

### DETAILED DESCRIPTION OF THE INVENTION

As noted above, in the first aspect of the present invention, there is provided a soup composition comprising at least one edible soup material and at least one edible binding/molding substance, the soup composition being in the form of a non-liquid shape.

Any edible soup material can be employed in accordance with the present invention, a wide variety of which are known and readily available. As noted above, in some embodiments of the present invention, the edible soup material is in powdered form. There are a number of soup companies, which produce and market dry soup mixes which are readily available to the public. Among them are Lipton® Onion Soup Mix, Knorr® Vegetable Soup Mix, and Campbell® Tomato Soup Mix. The last of these, Campbell® Tomato Soup Mix, is a representative example of a powdered soup for use according to the present invention.

In some embodiments according to the present invention, the edible soup material comprises at least one vegetable in addition to a primary dry soup mix ingredient. The at least one vegetable, when provided, can be any dried vegetable. A bean is a representative example of a vegetable for use according to the present invention.

In some embodiments of the present invention, more than one non-liquid shaped soup composition can be combined, e.g., an onion-shaped soup composition containing powdered onion soup can be combined with a bean-shaped soup composition containing powdered bean soup. This has the advantage that each ingredient can be formulated to prevent chemical interactions with the components of the other.

Any edible binding/molding substance, a variety of which are well-known and available to persons of skill in the art, can be employed in accordance with the present invention. The expression “binding/molding substance” means that a composition comprising the edible soup material being employed and the binding/molding substance is, or is capable of being processed such that it is, in the form of a non-liquid shape. Such edible binding/molding substances include any food grade (i.e. safe for use with food) complex sugars or starches.

In some embodiments of the present invention:

the edible binding/molding substance is partially hot-water soluble;

the edible binding/molding substance is hot-water soluble;

the edible binding/molding substance, when dissolved in hot water, exhibits the thickening and binding characteristics which allow the mixture to be molded into a non-liquid shape;

the edible binding/molding substance is suitable for mixing with the edible soup material; and/or

the edible binding/molding substance will not react or otherwise interfere with the molding process.

Representative examples of binding/molding substances which are suitable for use according to the present invention include Knox unflavored gelatin, agar, corn starch, and pectin.

In some embodiments of the present invention, the edible binding/molding substance is present in an amount of at least 1 percent by weight of the soup composition.

The phrase “with the soup composition being in the form of a non-liquid shape” contains the expressions “non-liquid” and “shape”. The expression “non-liquid” as used herein, means matter which is not flowable, and whose state at room temperature is not gas or liquid, but instead is either solid or one of the following colloids: solid sol, sol, gel, solid foam, or, in some cases, emulsion. The expression “shape” means the characteristic configuration, or form, of a thing; although it is not logical to apply “shape” to the edible soup material in powdered form (dry soup mix) because the soup ingredients lost their natural form when they were ground into powder, the expression “shape” may appropriately be conjoined with the expression “non-liquid”, whose possible states at room temperature all imply a definite form.

As noted above, according to the second aspect of the present invention, there is provided a method of making a soup composition, comprising:

mixing at least one edible soup material with at least one edible binding/molding substance to provide a soup mixture;

depositing the soup mixture into a mold; and

molding the soup mixture into a non-liquid shape, and according to the third aspect of the present invention, there is provided a method of making a soup composition, comprising:

depositing into a mold a soup mixture comprising at least one edible soup material and at least one edible binding/molding substance; and

molding the soup mixture into a non-liquid shape.

In some embodiments according to the second aspect or the third aspect of the present invention, molding the soup mixture comprises subjecting the soup mixture to a temperature in the range of from about 0 degrees C. to about 30 degrees C. and/or subjecting the soup mixture to relative humidity in the range of from about 35 percent to about 55 percent.

The phrases “depositing the soup mixture into a mold”, and “depositing into a mold a soup mixture” both make reference to a mold, which can be any hollow form for shaping a pliable substance. The substance hardens or sets inside the mold, adopting its shape. Any type of mold suitable for use with food can be employed in accordance with the present invention. Persons of skill in the art are aware of, and have access to, a wide variety of such molds. The size of the molded product can be any size which is consistent with the contents of a typical soup package. A representative example of a suitable mold and molded product size for use according to the present invention is a vacuum formed PETG (glycol-modified polyethylene teraphthalate) structure having a cavity in the shape of a flat (˜0.25 inch thick) tomato.

The phrase herein, namely “molding the soup mixture” refers to any process by which the soup mixture can be formed, or molded, into a particular non-liquid shape.

The soup composition which is provided as a result of exposing the soup mixture to the molding process can be in any non-liquid shape. As noted above, in some embodiments of the present invention, the non-liquid shape resembles the natural shape of the primary ingredient of the soup mix, or resembles the natural shape of one of the other natural foods (e.g., a tomato or a slice of a tomato) from which the soup material was obtained.

In some embodiments according to the present invention, the soup composition comprises at least one weak point. The expression “weak point”, as used herein, means any structural feature which facilitates fracturing the soup composition along the weak point into two or more pieces. Representative examples of weak points include indentations, scoring lines, perforations, previous breakage, etc. A representative example suitable for use according to the present invention is a large, dried tomato soup shape with light scoring lines to allow the user to cleanly break off sections to make, for example, a half cup of soup.

In some embodiments according to the present invention, the mold is such that the size of the molded product is, as noted above, consistent with the contents of a typical soup package, and further reduced to a fraction of that size. Representative examples suitable for use according to the present invention are tomato shapes, each having a thickness of approximately 0.125 inch (reduced from 0.25 inch thick) which are packaged in groups to allow the user to make as much or as little soup as possible.

In some embodiments according to the present invention, the non-liquid shape soup composition is added to water and heated, optionally with stirring, to prepare the soup for eating.

In some embodiments according to the present invention, more than one edible binding/molding substance can be combined. For example, Knox unflavored gelatin can be combined with agar in various relative concentrations in order to adjust the rate of dissolution upon mixing with water and heating (i.e., Knox gelatin dissolves more rapidly than agar)—varying such concentrations can also affect the consistency of the resulting soup.

In some embodiments according to the present invention, the concentration(s) of the one or more edible binding/molding substance can be varied to adjust the texture of the surface of the non-liquid shape.

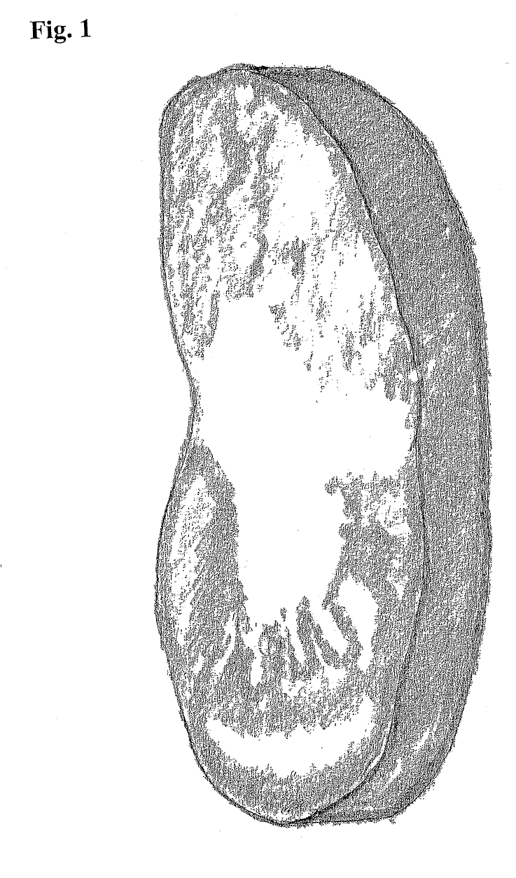

FIG. 1 depicts a first representative embodiment of a soup composition according to the present invention. The soup composition depicted in FIG. 1 was made by thoroughly mixing 1 percent by weight powdered tomato soup and the balance corn starch, to form a soup mixture, depositing the soup mixture in a mold cavity, the mold cavity being in the shape of a slice of tomato, subjecting the soup mixture to a temperature of 10 degrees C. and 45 percent humidity for three hours to convert the soup mixture to a non-liquid shape, removing the non-liquid from the mold, and decorating (e.g., with food coloring) the non-liquid shape to have the appearance of a tomato slice.

### EXAMPLES

The following are specific examples of methods of making soup compositions according to the present invention:

### Example 1

An agar/hot water solution was mixed with dried Lipton® tomato soup, poured into a plastic mold, and allowed to cool in a refrigerator for about five minutes. The result was a non-liquid shape having the shape of a tomato. The non-liquid tomato shape was then put into water, microwaved for one minute, and stirred. The result was a soup which had a taste similar to Lipton® tomato soup.

### Example 2

An agar/hot water solution was mixed with onion gravy mix, poured into a plastic mold, and allowed to cool in a refrigerator for about five minutes. The result was a non-liquid shape having the shape of an onion. The non-liquid onion shape was then put into water, microwaved for one minute, and stirred. The result was a gravy which had a taste similar to onion gravy from the mix.

### Example 3

A Knox unflavored gelatin/hot water solution was mixed with dried Lipton® tomato soup, poured into a plastic mold, and allowed to cool in a refrigerator for about five minutes. The result was a non-liquid shape having the shape of a tomato. The non-liquid tomato shape was then put into water, microwaved for one minute, and stirred. The result was a soup which had a taste similar to Lipton® tomato soup.

Any two or more structural parts of the soup compositions described herein can be integrated. Any structural part of the soup compositions described herein can be provided in two or more parts which are held together, if necessary. Similarly, any two or more functions can be conducted simultaneously, and/or any function can be conducted in a series of steps.

1. A soup composition, comprising:
at least one edible soup material; and
at least one edible binding/molding substance,
said soup composition being in the form of a non-liquid shape.

2. A soup composition as recited in claim 1, wherein said edible binding/molding substance is at least partially hot-water soluble.

3. A soup composition as recited in claim 1, wherein said edible soup material is powdered.

4. A soup composition as recited in claim 1, wherein said edible binding/molding substance comprises at least one material selected from the group consisting of gelatin, agar, corn starch, and pectin.

5. A soup composition as recited in claim 1, wherein said soup composition comprises at least one weak point.

6. A soup composition as recited in claim 1, wherein said edible binding/molding substance is present in an amount of at least 1 percent by weight of said soup composition.

7. A soup composition as recited in claim 1, wherein said edible soup material comprises tomato soup, and said non-liquid shape is a tomato shape.

8. A soup composition as recited in claim 1, wherein said edible soup material comprises onion soup, and said non-liquid shape is an onion shape.

9. A soup composition as recited in claim 1, wherein said edible soup material comprises carrot soup, and said non-liquid shape is a carrot shape.

10. A soup composition as recited in claim 1, wherein said edible soup material comprises potato soup, and said non-liquid shape is a potato shape.

11. A soup composition as recited in claim 1, wherein said edible soup material comprises at least one vegetable, and said non-liquid shape is the shape of said vegetable.

12. A soup composition as recited in claim 1, wherein said edible soup material comprises a bean, and said non-liquid shape is a bean shape.

13. A method of making a soup composition, the method comprising:
mixing at least one edible soup material with at least one edible binding/molding substance to provide a soup mixture;
depositing said soup mixture into a mold; and
molding said soup mixture into a non-liquid shape.

14. A method as recited in claim 13, wherein said molding said soup mixture comprises subjecting said soup mixture to a temperature in the range of from about 0 degrees C. to about 30 degrees C.

15. A method as recited in claim 14, wherein said molding said soup mixture comprises subjecting said soup mixture to relative humidity in the range of from about 35 percent to about 55 percent.

16. A method as recited in claim 13, wherein said molding said soup mixture comprises subjecting said soup mixture to relative humidity in the range of from about 35 percent to about 55 percent.

17. A method as recited in claim 13, wherein said edible binding/molding substance is at least partially hot-water soluble.

18. A method as recited in claim 13, wherein said edible soup material is powdered.

19. A method as recited in claim 13, wherein said edible binding/molding substance comprises at least one material selected from the group consisting of gelatin, agar, corn starch, and pectin.

20. A method of making a soup composition, the method comprising:
depositing into a mold a soup mixture comprising at least one edible soup material and at least one edible binding/molding substance; and
molding said soup mixture into a non-liquid shape.

21. A method as recited in claim 20, wherein said edible binding/molding substance is at least partially hot-water soluble.

22. A method as recited in claim 20, wherein said edible soup material is powdered.

23. A method as recited in claim 20, wherein said edible binding/molding substance comprises at least one material selected from the group consisting of gelatin, agar, corn starch, and pectin.

24. A method as recited in claim 20, wherein said edible soup material comprises at least one vegetable, and said non-liquid shape is the shape of said vegetable.
